(19) United States
(12) Patent Application Publication
(10) Pub. No.: US 2026/0300721 A1
(43) Pub. Date: Oct. 1, 2026

(54) METHODS AND SYSTEMS FOR GENERATING SYNTHETIC DATA FOR TRAINING A MACHINE LEARNING MODEL

(71) Applicant: TDK U.S.A. Corporation, Uniondale, NY (US)

(72) Inventors: Darby Michael LOSEY, Pittsburgh, PA (US); Juan S Mejia SANTAMARIA, San Jose, CA (US); Vishal VIJAYAKUMAR, Fremont, CA (US); Milad POOLADSANJ, Irvine, CA (US); Abbas ATAYA, Menlo Park, CA (US)

(73) Assignee: TDK U.S.A. Corporation, Uniondale, NY (US)

(21) Appl. No.: 19/559,802

(22) Filed: Mar. 6, 2026

Related U.S. Application Data
(60) Provisional application No. 63/781,303, filed on Mar. 31, 2025.
(60) Provisional application No. 63/781,318, filed on Mar. 31, 2025.

(51) Int. Cl. G06N 3/08; G06F 11/07

(52) U.S. Cl. CPC G06N 3/08; G06F 11/0736; G06F 11/079

(57) ABSTRACT

In a method for generating synthetic data for training a machine learning model, a generative model is trained on previously collected sensor time-series data, where the generative model is configured to generate synthetic sensor time-series data. The synthetic sensor time-series data is generated at the generative model based at least in part on the previously collected sensor time-series data, where the synthetic time-series sensor data is representative of a condition within a target operating environment. A machine learning model is trained based at least in part on the synthetic sensor time-series data, where the machine learning model is configured to monitor the condition of a device within the target operating environment. The machine learning model is deployed within the target operating environment, wherein the machine learning model monitors the condition of the device based at least in part on additional collected sensor time-series data collected within the target operating environment.

### RELATED APPLICATIONS

This application claims priority to and the benefit of U.S. Provisional Patent Application 63/781,303, filed on Mar. 31, 2025, entitled “GENERATIVE MODEL ADAPTATION TO ADDRESS COLD-START FOR CONDITION-BASED MONITORING IN INDUSTRIAL MACHINERY,” by Losey et al., having Attorney Docket No. IVS-1165-PR, and assigned to the assignee of the present application, which is incorporated herein by reference in its entirety.

This application also claims priority to and the benefit of U.S. Provisional Patent Application 63/781,318, filed on Mar. 31, 2025, entitled “CROSS-CONDITIONAL GENERATION USING A PRETRAINED GENERATIVE MODEL FOR CONDITION-BASED MONITORING IN INDUSTRIAL MACHINERY,” by Losey et al., having Attorney Docket No. IVS-1166-PR, and assigned to the assignee of the present application, which is incorporated herein by reference in its entirety.

### BACKGROUND

In many industries, equipment and machinery are critical to operations, and unexpected failures can lead to significant downtime, costly repairs, and safety hazards. Traditional maintenance approaches, such as scheduled maintenance, often fail to predict and prevent these failures because they do not account for the actual condition of the equipment. Condition-based monitoring (CBM) is a proactive maintenance strategy that involves monitoring using real-time data to assess the actual condition of equipment to determine when maintenance should be performed. CBM solutions require some amount of actual data to be built. However, in many circumstances, there is not enough available data, either under normal operating conditions or fault operating conditions, to build such CBM solutions.

### BRIEF DESCRIPTION OF DRAWINGS

The accompanying drawings, which are incorporated in and form a part of the Description of Embodiments, illustrate various non-limiting and non-exhaustive embodiments of the subject matter and, together with the Description of Embodiments, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 is a block diagram illustrating an example system for generating synthetic sensor time-series data and performing fault detection, in accordance with embodiments.

FIG. 2 is a block diagram illustrating an example data synthesis system, in accordance with embodiments.

FIG. 3 is a block diagram illustrating an example machine learning model training system, in accordance with embodiments.

FIG. 4 is a block diagram illustrating an example fault detection module, in accordance with embodiments.

FIG. 5 is a flow diagram illustrating an example method for generating synthetic sensor time-series data for training a machine learning model, according to embodiments.

FIG. 6 is a flow diagram illustrating an example method for generating synthetic sensor time-series data for training a machine learning model in a cold start situation, according to embodiments.

FIG. 7 is a flow diagram illustrating an example method for generating synthetic sensor time-series data for training a machine learning model for use across multiple operating conditions, according to embodiments.

### DESCRIPTION OF EMBODIMENTS

The following Description of Embodiments is merely provided by way of example and not of limitation. Furthermore, there is no intention to be bound by any expressed or implied theory presented in the preceding background or in the following Description of Embodiments.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of acoustic (e.g., ultrasonic) signals capable of being transmitted and received by an electronic device and/or electrical or magnetic signals capable of being stored, transferred, combined, compared, and otherwise manipulated in an electrical device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “collecting,” “synthesizing,” “training,” “retraining,” determining,” “combining,” “adapting,” “deploying,” “generating,” “deriving,” “analyzing,” “monitoring,” “processing,” “using,” “performing,” “outputting,” “defining,” “sampling,” “decoding,” “computing,” “executing,” “capturing,” or the like, refer to the actions and processes of an electronic device.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example ultrasonic sensing system and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Discussion begins with a description of an example system for synthesizing fault data and training a machine learning model for performing fault detection is then described. An example data synthesis system is then described. An example machine learning model training system is then described. An example fault detection system for performing fault detection based on the synthesized fault data is then described. Example operations of synthesizing fault data and training a machine learning model for performing fault detection are then described.

Mechanical equipment and machinery are critical components in numerous industrial applications, including aerospace, automotive, and energy production. Ensuring their reliability and performance is crucial, as faults in these systems can lead to catastrophic failures and costly downtime. Condition-based monitoring (CBM) is a proactive maintenance strategy that involves monitoring using real-time data from sensors to assess the actual condition of equipment to determine when maintenance should be performed. CBM solutions require some amount of actual data to be built. However, in many circumstances, there is not enough available data, either under normal operating conditions or fault operating conditions, to build such CBM solutions.

For instance, in deploying CBM solutions, a common issue occurs where data is needed to build a CBM solution, but without a CBM solution, it is difficult to acquire the initial data. This issue is called the “cold start” problem. Acquiring data for initial deployment of a CBM solution is very costly as it requires placing sensors in a factory or attached to a machine of interest. CBM solutions often require a very extensive dataset and this initial data collection period can often last many weeks. This data collection time is often very costly, as it is resource intensive and can often require onsite engineers to ensure data collection is continuing properly. The cold start problem can also lead to inefficiencies and increased costs, as it necessitates a prolonged period of manual data collection before any meaningful analysis can be performed. This delay hampers the timely deployment of CBM systems, which are crucial for ensuring the reliability and efficiency of industrial operations

In other situations, there can be an imbalance between the amount of data collected when the machine is in a normal operating state and the faulty state. Conventional CBM solutions are typically trained on data collected during normal machine operations, which means they perform well under those conditions but can struggle when faced with uncommon states like failures. In other words, conventional CBM solutions have difficulty generalizing effectively across different operating conditions, particularly under machine failure scenarios. Collecting data when a machine is in a faulty condition is more difficult and expensive because the machine typically spends less time in a faulty state and operating the machine in the faulty state may risk damage to the machine. The lack of data for when a machine is in a faulty state is a great challenge in developing CBM algorithms. Having access to data collected from a machine in a faulty state can improve accuracy and generalizability in CBM solutions.

To address the described cold start problem, embodiments described herein pretrain a generative model on previously collected sensor data from another device that is representative of a normal operating condition of the device for which monitoring is to be performed. In doing so, the generative model learns relevant structural patterns and dynamics. This pretrained generative model is then adapted for the target environment by incorporating any known parameters of the target environment. Synthetic sensor time-series data is then generated from this pretrained generative model under those specific conditions. This data is then used to train a machine learning model for deployment.

Upon deployment of the machine learning model, collected data during the monitoring process is used to further adapt/finetune the generative model. This fine-tuning process allows the generative model to generate synthetic sensor time-series data that even more closely mimics the real-world data of the target environment. The synthetic data is then used to update the machine learning model, e.g., improving the accuracy of the CBM predictions. The described embodiments thus enable the deployment of an effective CBM solution with reduced dependence on an initial data collection period. The iterative update ensures that the CBM solution is utilizing any new data that becomes available to further improve performance.

Using a generative model pretrained on a broad dataset of sensor data from one or more industrial environments captures general patterns and characteristics, enabling the generation of synthetic data even before specific data from the target environment is available. Additionally, the described embodiments include a fine-tuning process that adapts the generative model using any relevant data from the specific use-case, ensuring that the synthetic data closely mimics real-world conditions. The described embodiments allow for the immediate deployment of the CBM model using synthetic data generated from the pretrained generative model, providing a foundation for further data collection and model improvement based on collected data, ensuring improved accuracy and performance over time.

To address the described problem of generalizing machine monitoring across multiple conditions, the described embodiments generate synthetic data for uncommon machine states, such as failures, which are typically underrepresented in traditional datasets. The described embodiments allows CBM models to generalize more effectively across different operating conditions. Unlike conventional methods that rely heavily on real-world data, the described embodiments leverage a cross-conditional generative modeling paradigm to create realistic synthetic sensor time-series data. This process involves training a pretrained generative model on diverse normal operating conditions and then fine-tuning the generative model with limited data from failure conditions. The ability to generate high-quality synthetic data for rare states significantly enhances the performance and reliability of CBM models. Additionally, the flexibility to adapt the pretrained generative model to various failure conditions through fine-tuning provides a scalable and efficient solution for industrial monitoring systems.

Embodiments described herein provide methods and systems for generating synthetic data for training a machine learning model. A generative model is trained on previously collected sensor time-series data, where the generative model is configured to generate synthetic sensor time-series data based at least in part on the previously collected sensor time-series data. In some embodiments, the previously collected sensor time-series data is collected from at least one device not within a target operating environment and is representative of a normal operating condition of the device. In other embodiments, the previously collected sensor time-series data includes normal sensor time-series data and fault sensor time-series data collected from a device within a target operating environment, where the normal sensor time-series data is representative of a normal operating condition of the device and the fault sensor time-series data is representative of a fault operating condition of the device.

The synthetic sensor time-series data is generated at the generative model based at least in part on the previously collected sensor time-series data, where the synthetic time-series sensor data is representative of a condition within a target operating environment. In some embodiments, the generated synthetic sensor time series data is representative of a normal operating condition within the target operating environment. In some embodiments, the generated synthetic sensor time series data is representative of a fault operating condition within the target operating environment. A machine learning model is trained based at least in part on the synthetic sensor time-series data, where the machine learning model is configured to monitor the condition of a device within the target operating environment. In some embodiments, the machine learning model is a CBM machine learning model. The machine learning model is deployed within the target operating environment, wherein the machine learning model monitors the condition of the device based at least in part on additional collected sensor time-series data collected within the target operating environment. In some embodiments, the machine learning model is immediately deployed for monitoring the device using the synthetic sensor time-series data prior to availability of the additional collected sensor time-series data.

In some embodiments, the additional collected sensor time-series data is received at the generative model. The generative model is adapted to the target operating environment using the additional collected sensor time-series data. Additional synthetic time-series data is generated at the generative model based at least in part on the additional collected sensor time-series data. In some embodiments, the machine learning model is retrained based at least in part on the additional synthetic time-series data.

The embodiments described herein greatly extend beyond conventional methods of synthesizing data. The described embodiments provide methods for synthesizing sensor time-series data for use in training a machine learning model for which no training data is available (e.g., the cold start problem), reducing the time and cost needed for initial data collection. Other described embodiments provide methods for synthesizing sensor time-series data for use in training a machine learning model for use across different operational states, providing a comprehensive and adaptable machine learning model for performing system monitoring. The described embodiments also use the synthesized sensor time-series data representing intermediate operating states to perform CBM or predictive-based monitoring to detect or predict machine faults before they occur, thereby improving performance of the machines themselves.

### Example Systems for Generating Synthetic Time-Series Data and Training a Machine Learning Model

Example embodiments described herein provide methods and systems for training a machine learning model. A generative model is trained on previously collected sensor time-series data, where the generative model is configured to generate synthetic sensor time-series data. The synthetic sensor time-series data is generated at the generative model based at least in part on the previously collected sensor time-series data, where the synthetic time-series sensor data is representative of a condition within a target operating environment. A machine learning model is trained based at least in part on the synthetic sensor time-series data, where the machine learning model is configured to monitor the condition of a device within the target operating environment. The machine learning model is deployed within the target operating environment, wherein the machine learning model monitors the condition of the device based at least in part on additional collected sensor time-series data collected within the target operating environment.

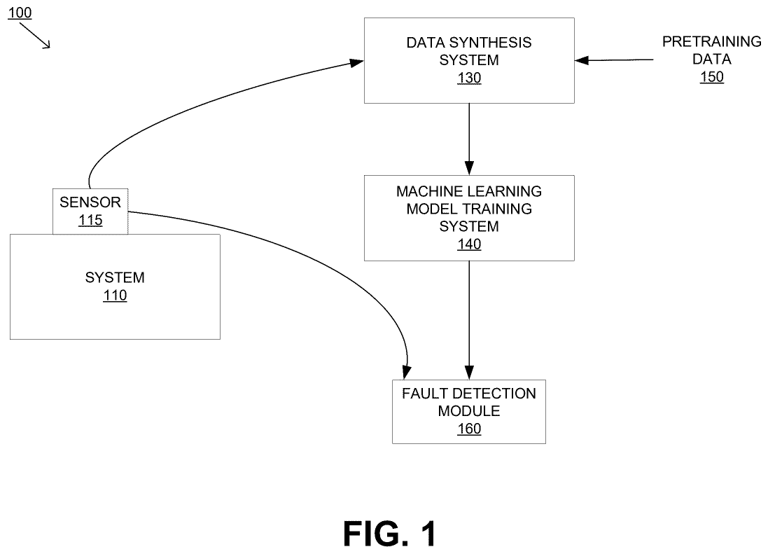

FIG. 1 is a block diagram illustrating an example system 100 for generating synthetic time-series data and performing fault detection, in accordance with embodiments. System 100 includes system 110 coupled to sensor 115, data synthesis system 130, and machine learning model training system 140. In some embodiments, system 100 also includes fault detection module 160. It should be appreciated that data synthesis system 130, machine learning model training system 140, and fault detection module 160 can be implemented as hardware, software, or any combination thereof. It should also be appreciated that data synthesis system 130, machine learning model training system 140, and fault detection module 160 may be separate components, may be comprised within a single component, or may be comprised in various combinations of multiple components, in accordance with some embodiments.

System 110 is equipment or machinery that moves during operation such that data can be collected by sensor 115. It should be appreciated that system 110 can be any time of industrial machine or equipment for which sensor time-series data can be captured, including but not limited to mechanical systems, rotor-bearing systems, motors, pumps, motors, industrial machines, etc. In some embodiments, the sensor time-series data collected by sensor 115 includes at least one of: vibration data, magnetic data, temperature data, pressure data, electric current data, and acoustic data.

Sensor 115 is coupled to system 110, and is capable of sensing vibrations or other information (e.g., pressure, acoustic, electrical current, temperature, etc.) from system 110 and capturing the vibrations as time-series data. It should be appreciated that, in some embodiments, sensor 115 is not directly coupled to system 110, but rather in the same environment as system 110 (e.g., factory floor or industrial complex) and is capable of sensing motion and vibrations from system 110. Sensor 115 captures time-series data when system 110 is in different and distinct operating states. For instance, sensor 115 captures time-series data while system 110 is operating under normal operating conditions (e.g., is in a healthy operating state) and while system 110 is operating under faulty operating conditions (e.g., is in a faulty operating state). As used herein, a “healthy” system refers to a system that is operating under normal operating conditions and a “faulty” system refers to a system that is operating under faulty operating conditions and is in a state of failure for purposes of performing its intended operations.

Sensor 115 includes at least one motion sensor, including without limitation: a gyroscope, an accelerometer, a magnetometer, and/or other motion sensors such as a pressure sensor and/or an ultrasonic sensor. It should be appreciated that sensor 115 can be any type of sensor capable of sensing vibrations and generating vibration data. In some embodiments, sensor 115 is comprised within a sensor processing unit (SPU). In various embodiments, sensor 115 is communicatively coupled with data synthesis system 130 via a wired or wireless interface, or other well-known means. In some embodiments, sensor 115 is communicatively coupled with machine learning model training system 140 and/or fault detection module 160 via a wired or wireless interface, or other well-known means.

In some embodiments, system 100 is configured to receive pretraining data 150 for training a generative model of data synthesis system 130. Pretraining data 150 includes sensor data that is relevant data to the use and operation of system 100. Pretraining data 150 can include a broad dataset of sensor data collected from various industrial environments, allowing for the training of a generative model before actual data from sensor 115 is available, allowing the generative model to capture general patterns and characteristics used for generating synthetic sensor data for a target condition to be monitored. It should be appreciated that pretraining data 150 can include data collected from various use cases, different systems or machines, and/or synthetic data designed to model real-world scenarios and operating conditions. In some embodiments, pretraining data 150 is previously collected sensor time-series data is collected from at least one device not within the operating environment of system 100 and is representative of a normal operating condition of the device from which it was captured. In some embodiments, pretraining data 150 is previously collected sensor time-series data is representative of sensor time-series data collected within the target operating environment.

Data synthesis system 130 is configured to receive at least one of sensor time-series data (e.g. from sensor 115 and/or pretraining data 150) and generate synthetic sensor time-series data representing at least one operating state (e.g., a normal operating state and/or a faulty operating state) or target condition. In some embodiments, data synthesis system 130 uses machine learning techniques and statistical models to generate the synthetic sensor time-series data.

In some embodiments, the synthetic data serves as a proxy for the actual data that would be collected during an initial data collection period used for training a machine learning model. The synthetic data is subsequently used to train a machine learning model (e.g., a CBM model), which can be a classifier, anomaly detection algorithm, or any other relevant machine learning model for monitoring system 110.

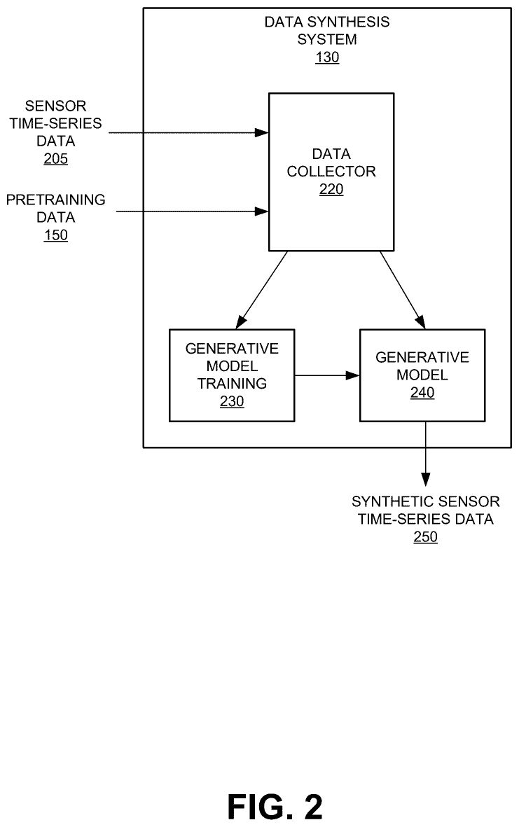

FIG. 2 is a block diagram illustrating an example data synthesis system 130, in accordance with embodiments. Data synthesis system 130 includes data collector 220, generative model training module 230, and generative model 240 for generating synthetic sensor time-series data 250 representing at least one operating state (e.g., a normal operating state and/or a faulty operating state) or a target condition.

Data collector 220 is configured to receive at least one of sensor time-series data 205 (e.g., from sensor 115) and/or pretraining data 150. In some embodiments, generative model training module 230 is configured to train generative model 240 using at least one of sensor time-series data 205 and/or pretraining data 150.

In some embodiments, where pretraining data 150 is used, generative model training module 230 trains generative model 240 such that generative model 240 captures general patterns and characteristics, enabling the generation of synthetic data even before specific data from the target environment is available. In some embodiments, generative model training module 230 trains generative model 240 using pretrained data 150 and a small amount of sensor time-series data 205.

In some embodiments, generative model training module 230 is configured to fine-tune generative model 240 as actual data (e.g., sensor time-series data 205) is received during operation. The fine-tuning allows for the generation of additional synthetic time series data 250 for adapting generative model 240 to more closely represent that conditions and nuances of the target environment including the monitored device (e.g., system 110).

In some embodiments, generative model training module 230 trains generative model 240 using at least one of data from non-target machine(s) performing related tasks (e.g., pretraining data 150), data from the target machine operating under normal operating conditions (e.g., sensor time-series data 205 representing a normal operating condition), and/or data from the machine operating under non-target conditions (e.g., sensor time-series data 205 representing a faulty operating condition).

In some embodiments, generative model training module 230 is configured to fine-tune generative model 240 as actual fault data (e.g., sensor time-series data 205 acquired during a faulty operating condition) is received during operation. The fine-tuning may also incorporate any known parameters of the faulty condition. The fine-tuning allows for the generation of additional synthetic time-series data 250 for adapting generative model 240 to more closely represent synthetic time-series data representing the faulty operating condition, also referred to as synthetic fault time-series data.

Generative model 240 receives sensor time-series data 205 representing one or more operating states and/or pretraining data 150. In some embodiments, generative model 240 is configured to incorporate physics-based constraints, domain knowledge, and pretraining on related tasks to generate the synthetic sensor time-series data of the at least one intermediate operating state. In some embodiments, generative model 240 includes at least one of: a temporal generative adversarial network (GAN), a recurrent variational autoencoder (VAE), a transformer-based sequence model, a deep neural network, and a function approximator capable of modeling complex sensor data distributions. In some embodiments, generative model 240 incorporates at least one of a recurrent, a convolutional, and a state-space architecture, to account for and incorporate temporal dependencies.

With reference to FIG. 1, in some embodiments, machine learning model training system 140 is configured to train a machine learning model based on at least one of sensor time-series data 205 and/or synthetic sensor time-series data 250.

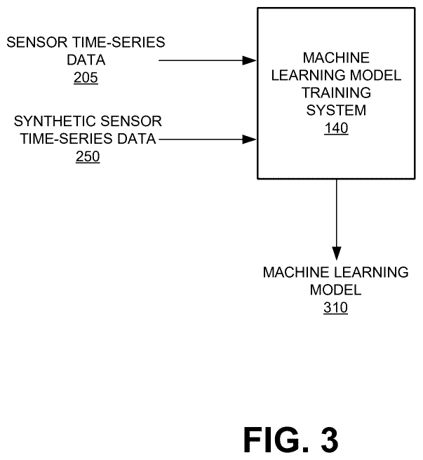

FIG. 3 is a block diagram illustrating an example machine learning model training system 140, in accordance with embodiments. Machine learning model training system 140 is configured to train machine learning model 310 using synthetic sensor time-series data 250. Machine learning model 310 can be deployed (e.g., to receive sensor data from system 110) to perform fault detection on system 110. The described embodiments provide for meaningful training of machine learning model 310 by using synthetic sensor time-series data 250. It should be appreciated that machine learning model training system 140 can train any number of machine learning models 310, with each being trained to identify a particular intermediate state. In some embodiments, machine learning model training system 140 also uses sensor time-series data 205 for training machine learning model 310.

In some embodiments, machine learning model 310 is configured to perform at least one of: anomaly detection, prediction of future values, or classification of an operating state of the system. In some embodiments, machine learning model 310 is a condition-based monitoring (CBM) machine learning model for predictive maintenance of the system (e.g., system 100) by enabling fault detection and failure forecasting.

With reference to FIG. 1, in some embodiments, system 100 also includes fault detection module 160 including a proxy machine learning model to perform the fault detection on system 110 on collected sensor time-series data.

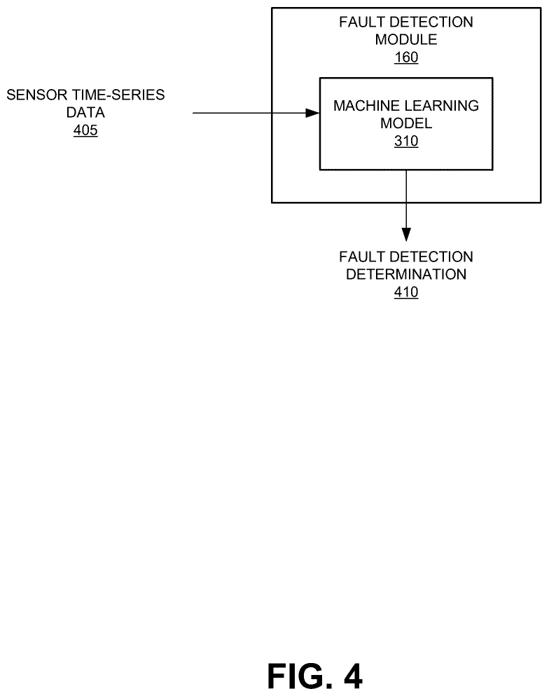

FIG. 4 is a block diagram illustrating example fault detection module 160, in accordance with embodiments. Fault detection module 160 includes machine learning model 310, which is trained to identify an operating state (e.g., a fault state) of the monitored system or machine (e.g., system 110). It should be appreciated that fault detection module 160 can include any number of machine learning models 310, with each being trained to identify a particular operating state.

Machine learning model 310 receives sensor time-series data 405. It should be appreciated that sensor time-series data 405 can be received from a sensor (e.g., sensor 115) or from another sensor in the target environment. Machine learning model 310 performs fault detection and diagnosis on sensor time-series data 405, and generates fault detection determination 410 (e.g., the system is healthy and operating under normal conditions or the system is experiencing a fault event).

### Example Methods of Operation

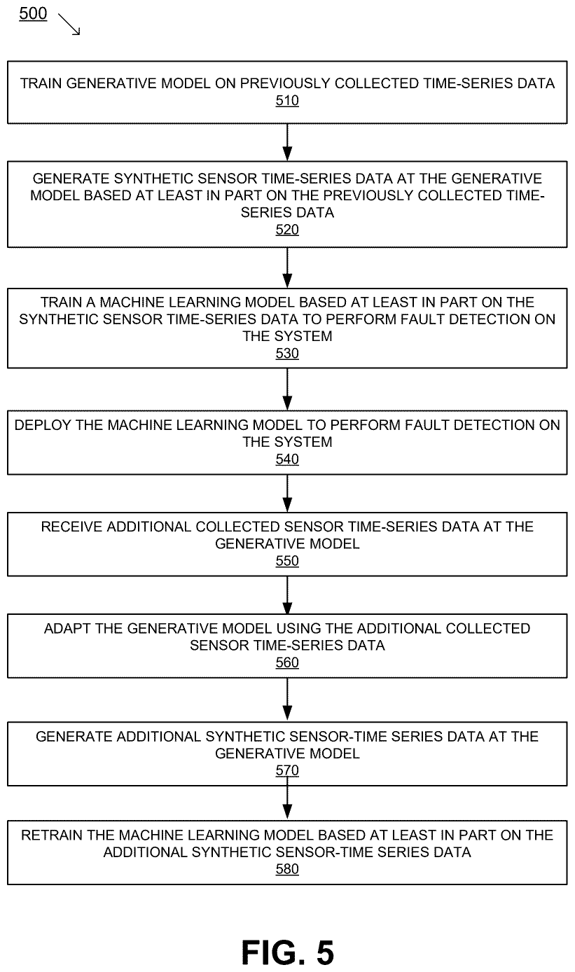

The following discussion sets forth in detail the operation of some example methods of operation of embodiments. With reference to FIGS. 5 through 7, flow diagrams 500, 600, and 700 illustrate example procedures used by various embodiments. Flow diagrams 500, 600, and 700 include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments. The computer-readable and computer-executable instructions, which reside on tangible computer readable storage media, are used to control, or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited for performing various other procedures or variations of the procedures recited in the flow diagram. Likewise, in some embodiments, the procedures in the flow diagram may be performed in an order different than presented and/or not all the procedures described in the flow diagram may be performed. It is further appreciated that procedures described in the flow diagrams may be implemented in hardware, or a combination of hardware with firmware and/or software provided by a computer system.

FIG. 5 is a flow diagram 500 illustrating an example method for generating synthetic sensor time-series data for training a machine learning model, according to embodiments. At procedure 510 of flow diagram 500, a generative model is trained on previously collected sensor time-series data, where the generative model is configured to generate synthetic sensor time-series data based at least in part on the previously collected sensor time-series data. In some embodiments, the previously collected sensor time-series data is collected from at least one device not within a target operating environment and is representative of a normal operating condition of the device. In other embodiments, the previously collected sensor time-series data includes normal sensor time-series data and fault sensor time-series data collected from a device within a target operating environment, where the normal sensor time-series data is representative of a normal operating condition of the device and the fault sensor time-series data is representative of a fault operating condition of the device.

At procedure 520, the synthetic sensor time-series data is generated at the generative model based at least in part on the previously collected sensor time-series data, where the synthetic time-series sensor data is representative of a condition within a target operating environment. In some embodiments, the generated synthetic sensor time series data is representative of a normal operating condition within the target operating environment. In some embodiments, the generated synthetic sensor time series data is representative of a fault operating condition within the target operating environment.

At procedure 530, a machine learning model is trained based at least in part on the synthetic sensor time-series data, where the machine learning model is configured to monitor the condition of a device within the target operating environment. In some embodiments, the machine learning model is a condition-based monitoring (CBM) machine learning model. At procedure 540, the machine learning model is deployed within the target operating environment, wherein the machine learning model monitors the condition of the device based at least in part on additional collected sensor time-series data collected within the target operating environment. In some embodiments, the machine learning model is immediately deployed for monitoring the device using the synthetic sensor time-series data prior to availability of the additional collected sensor time-series data.

In some embodiments, as shown at procedure 550, the additional collected sensor time-series data is received at the generative model. At procedure 560, the generative model is adapted to the target operating environment using the additional collected sensor time-series data. At procedure 570, additional synthetic time-series data is generated at the generative model based at least in part on the additional collected sensor time-series data. In some embodiments, as shown at procedure 580, the machine learning model is retrained based at least in part on the additional synthetic time-series data.

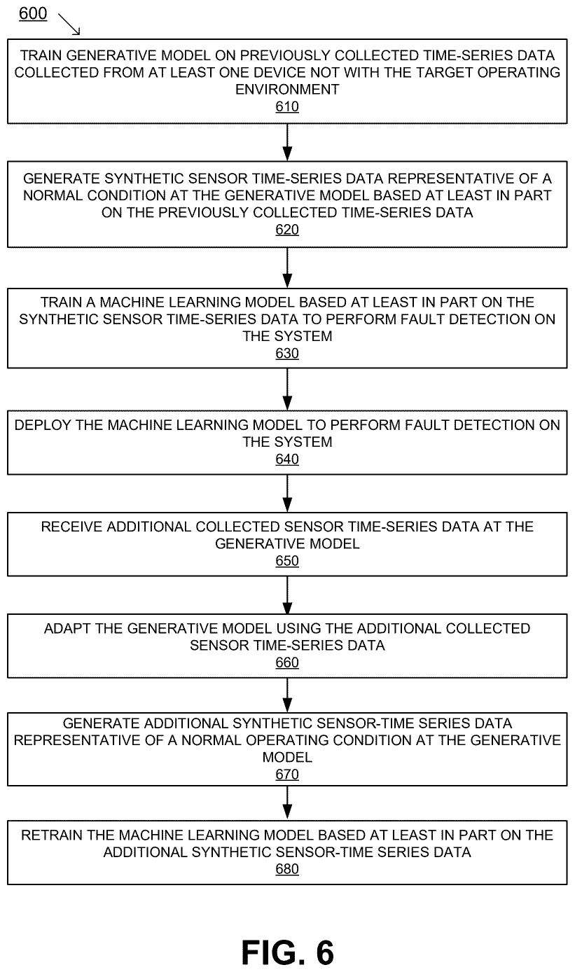

FIG. 6 is a flow diagram 600 illustrating an example method for generating synthetic sensor time-series data for training a machine learning model in a cold start situation, according to embodiments. At procedure 610 of flow diagram 600, a generative model is trained on previously collected sensor time-series data, where the generative model is configured to generate synthetic sensor time-series data based at least in part on the previously collected sensor time-series data. The previously collected sensor time-series data is collected from at least one device not within a target operating environment and is representative of a normal operating condition of the device.

At procedure 620, the synthetic sensor time-series data is generated at the generative model based at least in part on the previously collected sensor time-series data, where the synthetic time-series sensor data is representative of a condition within a target operating environment. The generated synthetic sensor time series data is representative of a normal operating condition within the target operating environment.

At procedure 630, a machine learning model is trained based at least in part on the synthetic sensor time-series data, where the machine learning model is configured to monitor the condition of a device within the target operating environment. In some embodiments, the machine learning model is a condition-based monitoring (CBM) machine learning model. At procedure 640, the machine learning model is deployed within the target operating environment, wherein the machine learning model monitors the condition of the device based at least in part on additional collected sensor time-series data collected within the target operating environment. In some embodiments, the machine learning model is immediately deployed for monitoring the device using the synthetic sensor time-series data prior to availability of the additional collected sensor time-series data.

In some embodiments, as shown at procedure 650, the additional collected sensor time-series data is received at the generative model. At procedure 660, the generative model is adapted to the target operating environment using the additional collected sensor time-series data. At procedure 670, additional synthetic time-series data is generated at the generative model based at least in part on the additional collected sensor time-series data. In some embodiments, as shown at procedure 680, the machine learning model is retrained based at least in part on the additional synthetic time-series data.

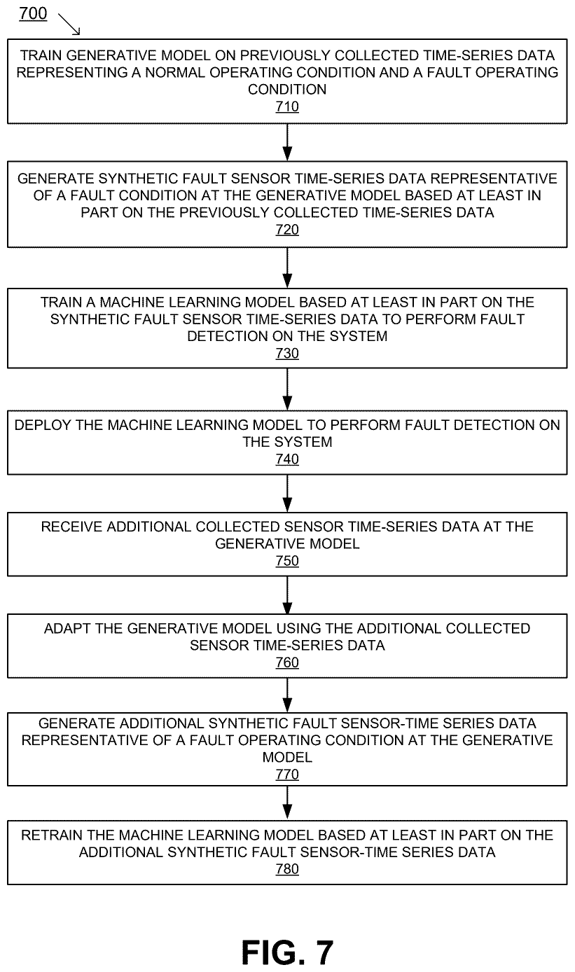

FIG. 7 is a flow diagram 700 illustrating an example method for generating synthetic sensor time-series data for training a machine learning model for use across multiple operating conditions, according to embodiments. At procedure 710 of flow diagram 700, a generative model is trained on previously collected sensor time-series data, where the generative model is configured to generate synthetic fault sensor time-series data based at least in part on the previously collected sensor time-series data. The previously collected sensor time-series data includes normal sensor time-series data and fault sensor time-series data collected from a device within a target operating environment, where the normal sensor time-series data is representative of a normal operating condition of the device and the fault sensor time-series data is representative of a fault operating condition of the device.

At procedure 720, the synthetic fault sensor time-series data is generated at the generative model based at least in part on the previously collected sensor time-series data, where the synthetic fault sensor time-series data is representative of a fault operating condition within the target operating environment.

At procedure 730, a machine learning model is trained based at least in part on the synthetic fault sensor time-series data, where the machine learning model is configured to monitor the condition of a device within the target operating environment. In some embodiments, the machine learning model is a condition-based monitoring (CBM) machine learning model. At procedure 740, the machine learning model is deployed within the target operating environment, wherein the machine learning model monitors the condition of the device based at least in part on additional collected sensor time-series data collected within the target operating environment. In some embodiments, the machine learning model is immediately deployed for monitoring the device using the synthetic sensor time-series data prior to availability of the additional collected sensor time-series data.

In some embodiments, as shown at procedure 750, the additional collected sensor time-series data is received at the generative model. At procedure 760, the generative model is adapted to the target operating environment using the additional collected sensor time-series data. At procedure 770, additional synthetic fault time-series data is generated at the generative model based at least in part on the additional collected sensor time-series data. In some embodiments, as shown at procedure 780, the machine learning model is retrained based at least in part on the additional synthetic fault time-series data.

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

1. A method for generating synthetic data for training a machine learning model, the method comprising:
training a generative model on previously collected sensor time-series data, wherein the generative model is configured to generate synthetic sensor time-series data based at least in part on the previously collected sensor time-series data;
generating the synthetic sensor time-series data at the generative model based at least in part on the previously collected sensor time-series data, wherein the synthetic time-series sensor data is representative of a condition within a target operating environment;
training a machine learning model based at least in part on the synthetic sensor time-series data, wherein the machine learning model is configured to monitor the condition of a device within the target operating environment; and
deploying the machine learning model within the target operating environment, wherein the machine learning model monitors the condition of the device based at least in part on additional collected sensor time-series data collected within the target operating environment.

2. The method of claim 1, wherein the previously collected sensor time-series data is collected from at least one device not within the target operating environment and is representative of a normal operating condition of the device.

3. The method of claim 2, wherein the previously collected sensor time-series data is representative of sensor time-series data collected within the target operating environment.

4. The method of claim 1, further comprising:
receiving the additional collected sensor time-series data at the generative model;
adapting the generative model to the target operating environment using the additional collected sensor time-series data; and
generating additional synthetic time-series data at the generative model based at least in part on the additional collected sensor time-series data.

5. The method of claim 4, further comprising:
retraining the machine learning model based at least in part on the additional synthetic time-series data.

6. The method of claim 1, wherein the machine learning model is immediately deployed for monitoring the device using the synthetic sensor time-series data prior to availability of the additional collected sensor time-series data.

7. The method of claim 1, wherein the previously collected sensor time-series data comprises normal sensor time-series data and fault sensor time-series data collected from the device within the target operating environment, wherein the normal sensor time-series data is representative of a normal operating condition of the device and the fault sensor time-series data is representative of a fault operating condition of the device.

8. The method of claim 7, wherein the generating, at the generative model, the synthetic sensor time-series data based at least in part on the previously collected sensor time-series data comprises:
generating synthetic fault sensor time-series data representative of a fault operating condition of the device.

9. The method of claim 8, wherein the training the machine learning model based at least in part on the synthetic sensor time-series data comprises:
training the machine learning model based at least in part on the synthetic fault sensor time-series data.

10. The method of claim 1, wherein the machine learning model is a condition-based monitoring (CBM) machine learning model.

11. A method for generating synthetic data for training a machine learning model, the method comprising:
training a generative model on previously collected sensor time-series data, wherein the generative model is configured to generate synthetic sensor time-series data based at least in part on the previously collected sensor time-series data, wherein the previously collected sensor time-series data is collected from at least one device not within a target operating environment and is representative of a normal operating condition of the device;
generating the synthetic sensor time-series data at the generative model based at least in part on the previously collected sensor time-series data, wherein the synthetic time-series sensor data is representative of a normal operating condition within the target operating environment;
training a machine learning model based at least in part on the synthetic sensor time-series data, wherein the machine learning model is configured to monitor the condition of a device within the target operating environment; and
deploying the machine learning model within the target operating environment, wherein the machine learning model monitors the condition of the device based at least in part on additional collected sensor time-series data collected within the target operating environment.

12. The method of claim 11, further comprising:
receiving the additional collected sensor time-series data at the generative model;
adapting the generative model to the target operating environment using the additional collected sensor time-series data; and
generating additional synthetic time-series data at the generative model based at least in part on the additional collected sensor time-series data.

13. The method of claim 11, further comprising:
retraining the machine learning model based at least in part on the additional synthetic sensor time-series data.

14. The method of claim 11, wherein the previously collected sensor time-series data is representative of sensor time-series data collected within the target operating environment.

15. The method of claim 11, wherein the machine learning model is a condition-based monitoring (CBM) machine learning model.

16. A method for generating synthetic data for training a machine learning model, the method comprising:
training a generative model on previously collected sensor time-series data, wherein the generative model is configured to generate synthetic fault sensor time-series data based at least in part on the previously collected sensor time-series data, wherein the previously collected sensor time-series data comprises normal sensor time-series data and fault sensor time-series data collected from a device within a target operating environment, wherein the normal sensor time-series data is representative of a normal operating condition of the device and the fault sensor time-series data is representative of a fault operating condition of the device;
generating the synthetic fault sensor time-series data at the generative model based at least in part on the previously collected sensor time-series data, wherein the synthetic fault time-series sensor data is representative of the fault operating condition within a target operating environment;
training a machine learning model based at least in part on the synthetic fault sensor time-series data, wherein the machine learning model is configured to monitor the condition of a device within the target operating environment; and
deploying the machine learning model within the target operating environment, wherein the machine learning model monitors the condition of the device based at least in part on additional collected sensor time-series data collected within the target operating environment.

17. The method of claim 16, further comprising:
receiving the additional collected sensor time-series data at the generative model;
adapting the generative model to the target operating environment using the additional collected sensor time-series data; and
generating additional synthetic time-series data at the generative model based at least in part on the additional collected sensor time-series data.

18. The method of claim 17, further comprising:
retraining the machine learning model based at least in part on the additional synthetic fault sensor time-series data.

19. The method of claim 16, wherein the machine learning model is a condition-based monitoring (CBM) machine learning model.
